(19) United States
(12) Patent Application Publication
(10) Pub. No.: US 2023/0159305 A1
(43) Pub. Date: May 25, 2023

(54) SMART HOOK BLOCK

(71) Applicant: MANITOWOC CRANE GROUP FRANCE SAS, DARDILLY (FR)

(72) Inventor: Stefan GOTTWALD, HUDE (DE)

(21) Appl. No.: 17/994,179

(22) Filed: Nov. 25, 2022

(30) Foreign Application Priority Data
Nov. 25, 2021 (DE) 102021130876.3

(51) Int. Cl. B66C 1/40; B66C 13/22; B66C 13/46

(52) U.S. Cl. CPC B66C 1/40; B66C 13/22; B66C 13/46; B66C 2700/067

(57) ABSTRACT

A crane hook block includes a frame, at least one pulley rotatably connected to the frame, a load hook connected to the frame, at least one sensor arranged on the crane hook block and designed to detect at least one ambient parameter and/or at least one status parameter of the crane hook block, and an interface connected to the at least one sensor and designed to transmit the data received from the at least one sensor.

### CROSS-REFERENCE TO RELATED APPLICATION

This application claims the benefit of and priority to German Patent Application No. 10 2021 130 876.3 filed on Nov. 25, 2021, the disclosure of which is incorporated herein by reference in its entirety.

### FIELD

The present invention relates to: a hook block for cranes, in particular mobile cranes, comprising a measurement sensor system for detecting parameters relating to the vicinity and/or status of the hook block; a crane controller which processes the measurement variables detected by the measurement sensor system; and a crane comprising such a hook block and/or such a crane controller.

### BACKGROUND

Conventional mobile cranes comprise a multitude of sensors which capture different measurement data and transmit them to a central data processing device and/or crane controller which determines status variables of the crane on the basis of the measurement data received, informs operating personnel accordingly and prevents impermissible statuses of the crane as applicable, for example by blocking individual crane functions. In known systems, individual status variables are calculated using multiple measurement values. In the case of mobile cranes, for instance, the load attached to the hook is regularly ascertained using pressure sensors on the luffing cylinder of the boom and multiple inclination sensors on the main boom and luffing boom. The same applies to the lifting height, which is regularly calculated using the length of lifting cable which has been wound or unwound, the telescopic length and the luffing angle of the boom.

However, indirectly calculating status variables from multiple measurement variables incurs the disadvantage that the likelihood of failure and measurement inaccuracy associated with each sensor not only increases the likelihood of a fault in the system as a whole, but also means that measurement errors can accumulate and thus result in the status variables being inaccurately determined.

### SUMMARY

The present invention is based on the object of providing an improved measurement sensor system for detecting status variables of a crane.

This object is achieved by the subject-matter of embodiments of the invention.

A crane hook block in accordance with the invention comprises a frame, at least one pulley connected to the frame, and a load hook connected to the frame, and also comprises at least one sensor arranged on the crane hook block and designed to detect at least one ambient parameter and/or at least one status parameter of the crane hook block, and an interface connected to the at least one sensor and designed to transmit the data received from the at least one sensor.

In other words, a sensor system is added to a conventionally designed crane hook block in order to take measurements directly at or in the region of the crane hook block and to be able to directly determine status variables of the crane on this basis, without having to elaborately derive them indirectly from multiple measurement values, which brings with it the disadvantages described above.

In order to be able to transmit the measurement data captured by the sensor or sensors to a crane controller, the crane hook block also comprises a data transmission interface. It is in principle conceivable to connect the interface of the crane hook block to a corresponding interface of the crane controller using a data cable, although a wireless radio connection between the corresponding interfaces is preferable here.

On the one hand, ambient parameters can be detected by means of the present invention in the immediate or near vicinity of the hook block. One or more selected sub-regions or the entire vicinity of the crane hook block can for example be monitored by means of camera and/or video image acquisition. The images or image data produced can provide information about the vicinity of the crane hook block directly on a screen arranged for example in the crane cabin. Using these data, it is for example possible to check whether the crane hook block is situated directly above a load to be attached or whether any obstacles are situated in the region of the lifting cable, the crane hook block or the load which need to be taken into account. It should be noted at this juncture that the images or image data generated can be subjected to automated, computer-assisted image processing in a known way, in order to automatically identify depicted objects and to feed the data obtained to the operating personnel or the crane controller. It is for example possible to automatically issue warnings about possible obstacles or people in the operating region of the hook block and as applicable to restrict or even block crane functions for safety reasons.

The distance between the crane hook block and people or objects and/or obstacles can also be detected by means of suitable optical sensors or other suitable sensors on the crane hook block. This enables not only the distance between the hook and a load to be attached but also the distance between the crane hook block and the pulley head at the tip of the boom to be detected. The latter application offers the advantage that an impending collision between the crane hook block and the pulley head is identified well before actual contact is made, and suitable measures can be taken, such as for example increasing the deceleration of the lifting movement in accordance with the decreasing distance from the pulley head. This avoids suddenly and therefore disadvantageously stopping the lifting movement in order to prevent a collision, as is the case when using conventional electromechanical lifting limit switches.

The measurements taken directly at the hook block can however also relate to the crane hook block itself. One or more sub-regions or the entire crane hook block can for instance be monitored by means of image and/or video image acquisition. As already noted above, the image and/or video data thus obtained can be brought to the attention of the personnel operating the crane or can be subjected to computer-assisted image processing in order for instance to automatically identify particular statuses of the crane hook block. It is thus for example possible to detect how many of the pulleys provided are occupied by or reeved with the lifting cable, or whether the clevis lock on the crane hook is in the correct position.

The present invention offers a greatly significant advantage with regard to directly measuring, on the crane hook block, the weight of the load attached to the load hook, since in previous solutions, the load weight was calculated indirectly from other sensor variables or was measured only to an insufficient level of accuracy by remote sensors arranged for example on the lifting cable drum.

By means of suitable spatial position sensors, for example GPS sensors, it is also possible to detect the (absolute) spatial position of the crane hook block. If one or more reference sensors are provided on the crane itself or on any objects, such as obstacles, loads to be attached and/or a setting-down position for a load, then their positions relative to these sensors and therefore also to any crane components or aforesaid objects and/or positions can also be ascertained.

The same considerations apply to the spatial orientation of the crane hook block. As soon as an inclined position of the crane hook block is identified using suitable sensors, this can for example be used to deduce an undesired “diagonal pull”, in which the crane hook block is not situated exactly above a load to be lifted and which would result in said load oscillating erratically when lifted. Any swinging of the load can in principle be detected via the spatial orientation, i.e. the inclined position and/or an acceleration of the crane hook block.

It is also possible to detect the rotational speed or rotational path of at least one or more or all of the pulleys provided on the crane hook block. It is thus possible to detect which and how many of the pulleys provided are occupied by or reeved with the lifting cable. By adducing a measurement value with regard to the length of lifting cable which has since been wound or unwound from the lifting cable drum, it is possible to ascertain the cable shear, i.e. the number of pulleys occupied by or reeved with the lifting cable, from the rotational speed and/or the rotational path of the at least one pulley. Additionally or alternatively, the cable shear can also however be ascertained by detecting the change in the lifting height of the crane hook block and detecting the length of lifting cable which has since been wound or unwound.

The crane hook block in accordance with the invention can comprise any number of the following sensors for detecting the measurement variables described above or other measurement variables:
an optical camera for detecting light in the visible and/or infrared part of the electromagnetic spectrum which is reflected and/or emitted in particular by the crane hook block or parts of it or by objects in the vicinity of the crane hook block;
a RADAR sensor, in particular for detecting the distance between the crane hook block and objects in the vicinity of the crane hook block;
a LI DAR sensor, in particular for detecting the distance between the crane hook block and objects in the vicinity of the crane hook block;
a spatial position sensor or GPS sensor, in particular for detecting the spatial position and/or orientation of the crane hook block;
an inclination sensor, in particular for detecting the spatial orientation of the crane hook block or parts of it;
a pressure sensor and/or force sensor, in particular for detecting the mechanical load on the crane hook block or parts of it;
a rotational speed sensor for detecting the rotational speed of at least one and in particular all of the pulleys;
an accelerometer, in particular for detecting the acceleration of the crane hook block or parts of it.

The measurement data obtained from the aforementioned sensors can be captured individually and in any expedient combination in order to determine any or for example the aforementioned ambient parameters or status parameters of the crane hook block. It is also possible to detect any of these ambient parameters and/or status parameters redundantly on the basis of different measurement variables or combinations of measurement variables.

It is also conceivable for the crane hook block to comprise a lighting unit which serves to illuminate at least some of the detection region of a camera or video camera, so as to for example obtain a usable camera image even at night or during twilight or in insufficient daylight.

It is in principle conceivable to supply electrical power via cables to the sensors provided on the crane hook block, the interface and any control devices provided, although an autonomous power supply, for example by means of an energy storage and/or a generator, is preferable.

The crane hook block can for instance comprise a generator for supplying electrical power to the sensors. Within this context, it would in principle be conceivable to equip the crane hook block with a wind generator, a photovoltaic generator or a generator which is driven mechanically by an internal combustion engine or the at least one pulley, wherein more than one of these generators could also be used.

As an alternative to such a generator or in addition to such a generator, the crane hook block can comprise an energy storage which can for example be charged by means of an external power source and/or the generator, so as to supply electrical power to the sensors, the interface and any other electrical consumers provided on the crane hook block.

It is also conceivable for the crane hook block to comprise an upper portion, comprising the at least one pulley, and a lower portion comprising the load hook, which are detachably connected, for example bolted, to each other. Such a crane hook block designed in multiple parts, in particular two parts, offers the advantage that the lower part can be easily separated from the rest of the crane hook block and even from the crane while leaving the lifting cable reeved. In order, among other things, to simplify maintenance and repair work on the sensor system, it is expedient to assign most or even all of the sensors as well as the associated interface to the lower part of the crane hook block. This enables the present invention to be used on multiple cranes with only one lower part of the hook block, without having to provide such a measurement sensor system for each crane. If, for example, a crane is to be used for tasks for which the measurement sensor system in accordance with the invention is to be used, only the lower part of the hook block has to be equipped for this purpose, while the reeving on the upper part of the hook block can remain.

Within this context, it is also expedient to also integrate the peripherals required for the sensors, i.e. the power generator and/or energy storage, control devices or the data interface, into the lower part of the hook block as far as possible.

Another aspect of the present invention relates to a crane controller for a crane, in particular a mobile crane, comprising an interface which can be connected to the interface of the crane hook block described above, wherein the crane controller ascertains at least one status variable of the crane on the basis of at least one parameter detected by at least one sensor. The function of the crane controller is not however limited to ascertaining one or more status variables of the crane; rather, it can also control or regulate one or more crane functions, such as lifting and lowering the load, swiveling the crane superstructure, and luffing or telescoping the crane boom in or out, on the basis of the captured measurement data and/or the detected status variables of the crane. If, for example, the distance between the crane hook block and the pulley head of the boom falls below a predetermined threshold value, the lifting speed can be reduced or a continued lifting movement can even be blocked. If an impermissible diagonal pull is identified, the lifting movement can again be blocked. In the simplest case, the measurement data obtained (for example camera images) and/or particular status variables of the crane (for example, the cable shear) are brought to the attention of the personnel operating the crane. The personnel can also be notified of critical measurement values (for example, the presence of obstacles in the vicinity of the crane hook block) or critical status variables (for example, an impending overload).

For instance, the crane controller can for example use the position of the hook block, detected by means of the GPS sensor, to deduce the telescopic length of the crane boom. The horizontal relative position between the crane hook block and the crane vehicle is known from GPS sensors on the crane hook block and the crane vehicle. Both the crane undercarriage and the crane boom are equipped with inclination sensors as standard, providing measurement data which can be used to deduce both the inclination of the crane vehicle and the luffing angle of the crane boom. Assuming that the crane hook is suspended vertically from the boom head, it is possible to deduce the boom length by simply calculating the angle.

The present invention also relates to a crane, in particular a mobile crane, comprising a crane hook block in accordance with any one of the embodiments described above and/or comprising a crane controller as described above.

Individual preferred features of the present invention are explained below. The invention can comprise the features described above and also the features described below, individually and in any expedient combination.
The weight of a load attached to the load hook can be measured by a so-called “load measurement bolt”, for example a crossbar of the hook block provided for the load hook. For this purpose, one or more sensors can for example be provided which measure the stress on the crossbar, thus allowing the load to be directly deduced.
The spatial position of the load hook relative to the crane can be ascertained by a spatial position sensor or GPS sensor on the hook block and a corresponding reference sensor on the crane.
The cable shear can be ascertained automatically from the detected cable length/position of the main/auxiliary lifting mechanism and the relative change in the position of the hook block.
The function of the lifting limit switch is provided in a contactless way by the sensor system of the hook block, which also identifies impending collisions with obstacles such as buildings or trees.
The crane operator's view of the load, the vicinity and of people is improved by a camera on the hook block. The images recorded are made available to the crane operator on the display of each active control location. The crane operator can for example observe the load even in regions which are hidden by obstacles or otherwise not visible. A lighting device can be provided for viewing in the dark.
An inclination sensor on the hook block identifies a diagonal pull of the load which is impermissible for crane operations. This sensor can also be used to compensate for and/or counteract the swinging movement of the load due to inertia when a drive mechanism, in particular the slewing mechanism, is started/stopped.
The power supply can be provided by rechargeable batteries in the hook block which can be charged by a direct current generator when the crane is in operation and at a socket on the crane vehicle when the vehicle is in motion. A socket can for example be provided in the front region of the operator's cabin, near the hook block which is secured to the front clevis of the crane, although the DC generator can also be driven by the pulleys of the hook block.
The measurement data captured by the sensors are detected by a controller comprising an integrated radio transceiver on the hook block and transferred to the crane controller, where they are processed.

### BRIEF DESCRIPTION OF THE DRAWINGS

Preferred embodiments of the present invention are explained in more detail below by referring to the enclosed figures. The invention can comprise any of the features described here, individually and in any expedient combination. There is shown:

FIG. 1 a single-part crane hook block in accordance with the present invention;

FIG. 2 a two-part crane hook block in accordance with the present invention;

FIG. 3 a mobile crane comprising the crane hook block in accordance with the invention and a corresponding crane controller.

### DESCRIPTION

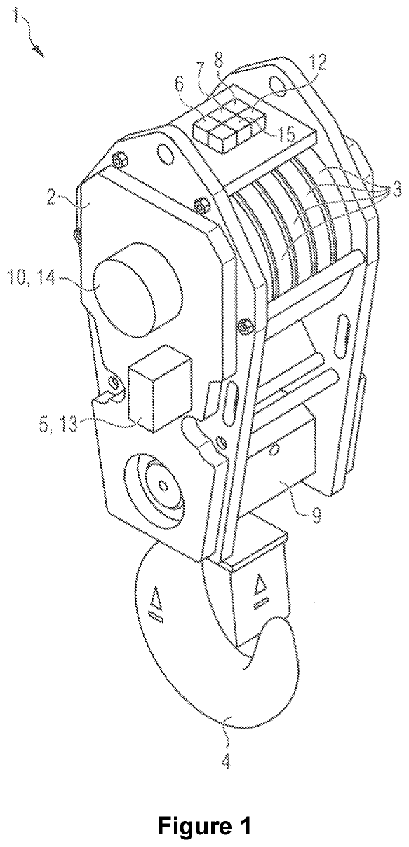

FIG. 1 shows a single-part crane hook block 1 in which both the total of six pulleys 3 and the single load hook 4 are connected to a common frame 2 of the crane hook block 1. To this extent, the crane hook block in accordance with the invention does not differ from conventional crane hook blocks.

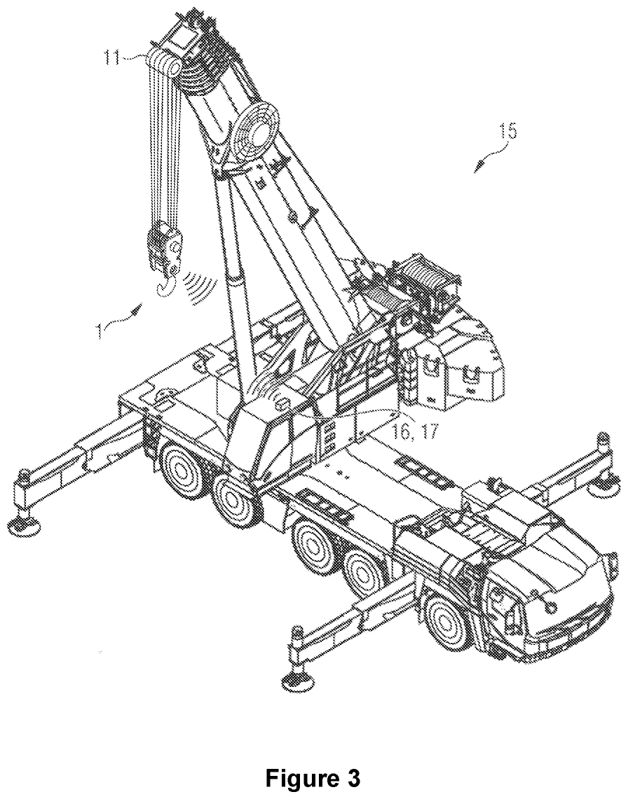

In order to enable particular ambient parameters and status parameters of the crane hook block to be measured directly, the crane hook block comprises multiple sensors 5 to 10. In order to measure the weight of the load attached to the load hook 4, the hook crossbar comprises a load sensor 9 in the form of strain gauges. In order to allow the operating personnel an improved view of the load attached to the crane hook 4, the frame 2 comprises a camera 5 featuring an integrated lighting device 13 in the form of a spotlight. The rotational speed of the pulleys 3 is detected by a corresponding rotational speed sensor 10. In order to preclude any possible collisions with the pulley head 11 (see FIG. 3) of the crane boom, the crane hook block 1 comprises a RADAR sensor 6 in its upper region, for detecting distances. Alternatively, a LI DAR sensor can also be used for this purpose. In order to detect the spatial position of the crane hook block 1, a spatial position sensor in the form of a GPS sensor 7 is provided. In addition, an inclination sensor 8 which is also situated on the crane hook block 1 detects the spatial orientation of the crane hook block 1 and can identify any possible inclined positions of the crane hook block 1.

All of the sensors 5 to 10 are connected to an interface 12 which receives the measurement data ascertained by the sensors 5 to 10 and transmits them to a corresponding interface 16 of a crane controller 17 (see FIG. 3) via a radio connection.

Electrical power is supplied to the entire measurement sensor system, including the sensors 5 to 10, by a rechargeable battery 15 which is in turn charged by a generator 14. The generator 14 is connected to the pulleys 3 via a shaft and thus generates electrical power when the crane hook block 1 is lifted or lowered.

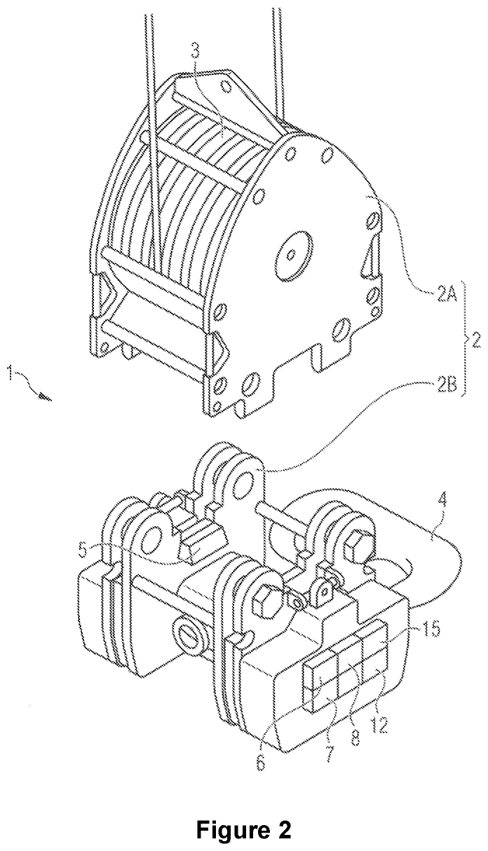

FIG. 2 shows another, two-part embodiment of the crane hook block in accordance with the invention which differs from the embodiment shown in FIG. 1 substantially only in that the frame 2 comprises an upper part 2A comprising the pulleys 3 and a lower part 2B comprising a double hook 4. The lower part 2B can be detachably connected to the upper part 2A using four bolt connections which are not indicated in any greater detail. FIG. 2 also shows that the entire measurement sensor system, including the sensors 5 to 10, the interface 12 and the energy storage 15, is arranged in the lower part 2B of the crane hook block 1. The rotational speed as well as the angular position of the individual pulleys 3 is detected by an optical camera 5 and a computer-assisted image evaluator which identifies optical markings on the pulleys 3 in the images produced by the camera 5, from which the rotational speed and angular position of the pulleys 3 is deduced. This feature could alternatively be realized by a ring of sensors on at least one pulley 3 and a corresponding Hall sensor in the lower part 2B of the hook block.

FIG. 3 shows a mobile crane 15 comprising the hook block 1 in accordance with the invention and a corresponding crane controller 17 together with an interface 16 comprising the feature already discussed further above for determining status variables of the crane 15 on the basis of the parameters detected by the sensors 5 to 10.

1-10. (canceled)

11. A crane hook block, comprising:
a frame;
at least one pulley rotatably connected to the frame;
a load hook connected to the frame;
at least one sensor arranged on the crane hook block and configured to detect at least one ambient parameter and/or at least one status parameter of the crane hook block; and
an interface connected to the at least one sensor and configured to transmit the data received from the at least one sensor.

12. The crane hook block according to claim 11, wherein at least one of the following parameters is detected as an ambient parameter:
a camera image of at least one region surrounding the crane hook block;
the distance between the crane hook block and objects.

13. The crane hook block according to claim 11, wherein at least one of the following parameters is detected as a status parameter:
a camera image of at least some of the crane hook block;
the weight of the load attached to the load hook;
the spatial position of the crane hook block;
the spatial orientation of the crane hook block;
the rotational speed of at least one pulley.

14. The crane hook block according to claim 11, comprising at least one of the following sensors:
an optical camera for detecting light in the visible and/or infrared part of the electromagnetic spectrum which is reflected and/or emitted by the crane hook block or parts of it or by objects in the vicinity of the crane hook block;
a RADAR sensor for detecting the distance between the crane hook block and objects in the vicinity of the crane hook block (1);
a LIDAR sensor for detecting the distance between the crane hook block and objects in the vicinity of the crane hook block;
a spatial position sensor or GPS sensor for detecting the spatial position and/or orientation of the crane hook block;
an inclination sensor for detecting the spatial orientation of the crane hook block or parts of it;
a pressure sensor and/or force sensor for detecting the mechanical load on the crane hook block or parts of it;
a rotational speed sensor for detecting the rotational speed of at least one of the pulleys;
an accelerometer for detecting the acceleration of the crane hook block or parts of it.

15. The crane hook block according to claim 11, further comprising a lighting unit for illuminating the detection region of a camera which captures the camera image.

16. The crane hook block according to claim 11, further comprising a generator for supplying electrical power to the sensors, wherein the generator is driven by the at least one pulley.

17. The crane hook block according to claim 11, further comprising an energy storage for supplying electrical power to the sensors.

18. The crane hook block according to claim 11, comprising an upper portion, which comprises the at least one pulley, and a lower portion which is detachably connected to the upper portion and comprises the load hook, wherein most of the sensors are arranged on or in the lower portion.

19. A crane controller for a crane, comprising an interface configured to be connected to the interface of the crane hook block according to claim 11, wherein the crane controller is configured to determine at least one status variable of the crane on the basis of a parameter detected by the at least one sensor.

20. A crane comprising:
a crane hook block comprising:
a frame;
at least one pulley rotatably connected to the frame;
a load hook connected to the frame;
at least one sensor arranged on the crane hook block and configured to detect at least one ambient parameter and/or at least one status parameter of the crane hook block; and
an interface connected to the at least one sensor and configured to transmit the data received from the at least one sensor; and
a crane controller comprising an interface configured to be connected to the interface of the crane hook block, wherein the crane controller is configured to determine at least one status variable of the crane on the basis of a parameter detected by the at least one sensor.
